(19) United States
(12) Patent Application Publication
(10) Pub. No.: US 2013/0198048 A1
(43) Pub. Date: Aug. 1, 2013

(54) PROFESSIONAL EMPLOYMENT ORGANIZATION DATA MANAGEMENT SYSTEM

(71) Applicant: AlphaCare Services, Inc., Toledo, OH (US)

(72) Inventors: Gerald L. Tillman, JR., Toledo, OH (US); Jeremy T. Spurling, Toledo, OH (US)

(73) Assignee: ALPHACARE SERVICES, INC., Toledo, OH (US)

(21) Appl. No.: 13/751,222

(22) Filed: Jan. 28, 2013

Related U.S. Application Data
(60) Provisional application No. 61/591,309, filed on Jan. 27, 2012.

(51) Int. Cl. G06Q 10/10

(52) U.S. Cl. CPC G06Q 10/105
USPC 705/32

(57) ABSTRACT

A data management system includes a computer readable storage medium with a software program embodied thereon, having a human resources application, a reports center application, a payroll processing application, and a system maintenance application. The system also includes data from one or more time files. The data management system is capable of generating one or more payroll documents and one or more reports based on information included in one or more of the human resources application, the reports center application, the payroll processing application, and the system maintenance application, and the data from the one or more time files.

### CROSS-REFERENCE TO RELATED APPLICATIONS

This application claims priority to U.S. Provisional Application Ser. No. 61/591,309, filed on Jan. 27, 2012, the entire disclosure of which is hereby incorporated herein by reference.

### FIELD OF THE INVENTION

The invention relates to a data management system, and more specifically to a system and method for managing Professional Employment Organizations in the construction industry and union environment.

### BACKGROUND OF THE INVENTION

Various computer-based systems are commonly used to manage different aspects of a business. Many computer-based systems that are currently available include features that allow users to manage payroll and benefits, and keep track of employee and employer data. For example, U.S. Pat. No. 6,401,079 discloses a payroll system including profile information on employers and employees, timesheets, salary and hourly wage data, overtime data, and employee benefit data. Likewise, U.S. Pat. No. 7,941,351 teaches a method for providing payroll services to an employer by obtaining employee and employer personal and tax data and managing payroll and taxes of the employer. U.S. Pat. No. 5,613,625, and U.S. Patent Application Publication No. 2009/0114679 also disclose some of the more common features. The entire disclosures of each of the above-mentioned patents and patent application are hereby incorporated herein by reference.

Computer-based systems known in the art have generally not met all of the unique requirements for professional employment organizations or PEOs. For example, typical data management systems have not been capable of combining union payments and contractual requirements in multiple states in order to generate payroll for employees working multiple jobs under various union and contractual requirements. Furthermore, a single computer-based system capable of also calculating taxes and worker compensation payments under multiple union and contractual requirements has not previously been available.

It is desirable to have a single data management system capable of combining employee information, employer information, union information, and various government, contractual, and other requirements in order to calculate payroll, union fees, government fees, and other payments and fees, and to produce associated payroll and other documents such as paychecks, tax documents, worker's compensation payments, and reports for union employees, unions, and government agencies.

### SUMMARY OF THE INVENTION

Consonant with the present invention, a single data management system capable of combining employee information, employer information, union information, and various government, contractual, and other requirements in order to calculate payroll, union fees, government fees, and other payments and fees, and to produce associated payroll and other documents such as paychecks, tax documents, worker's compensation payments, and reports for union employees, unions, and government agencies, has surprisingly been discovered.

In one embodiment of the disclosure, a data management system including a software program including a human resources application, a reports center, a payroll processing application, and a system maintenance application is disclosed. The system also includes data from one or more time files. The data management system is capable of generating one or more payroll documents and one or more reports based on information included in one or more of the human resources application, the reports center, the payroll processing application, and the system maintenance application, and the data from the one or more time files.

In another embodiment of the disclosure, a data management system configured to manage a professional employment organization in a union construction environment is disclosed. The system includes a computer having a processor for executing instructions, a memory including at least one database in communication with the processor, a display, and an input device in communication with the processor. The system further includes a software program including a human resources application including an employee module, a client company module, and a union module, a reports center, a payroll processing application, and a system maintenance application. Data from one or more time files is also included. The input device permits a user to generate one or more payroll documents and one or more reports based on information included in one or more of the human resources application, the reports center, the payroll processing application, and the system maintenance application, and the data from the one or more time files.

In yet another embodiment of the disclosure, a method of managing a professional employment organization in a union construction environment is disclosed. The method includes the steps of providing a data management system including a software program having human resources application, a reports center, a payroll processing application and a system maintenance application, and providing a time file for at least one employee. Additional steps include generating a separate file including a data set from one or more of the human resources application, the reports center, the payroll processing application, the system maintenance application, and the time file, generating payroll documents based on the data set, and generating reports based on the data set. Also an invoice is sent to one or more client companies detailing payments made to or on behalf of the at least one employee.

### BRIEF DESCRIPTION OF THE DRAWINGS

The above, as well as other advantages of the present invention, will become readily apparent to those skilled in the art from the following detailed description when considered in the light of the accompanying drawings, in which:

FIG. 1 is a schematic diagram of a data management system according to one embodiment of the disclosure;

FIG. 2 is a screen print of an interactive user interface displaying data management system applications according to one embodiment of the invention;

FIG. 3 is a screen print of the navigational tools available in a human resources application of the data management system shown in FIG. 2;

FIG. 4 is a screen print of the navigational tools available in an employee module in FIG. 3;

FIG. 5 is a screen print of the navigational tools available in a union module in FIG. 3;

FIG. 6 is a screen print of the navigational tools available in a reports center of the data management system shown in FIG. 2;

FIG. 7 is a screen print of the navigational tools available in a system maintenance application of the data management system shown in FIG. 2; and

FIG. 8 is a flow diagram of a method for managing Professional Employment Organizations according to an embodiment of the disclosure.

### DETAILED DESCRIPTION OF AN EMBODIMENT OF THE INVENTION

The following detailed description and appended drawings describe and illustrate an exemplary embodiment of the invention. The description and drawings serve to enable one skilled in the art to make and use the invention, and are not intended to limit the scope of the invention in any manner. In respect of the methods disclosed, the steps presented are exemplary in nature, and thus, are not necessary or critical.

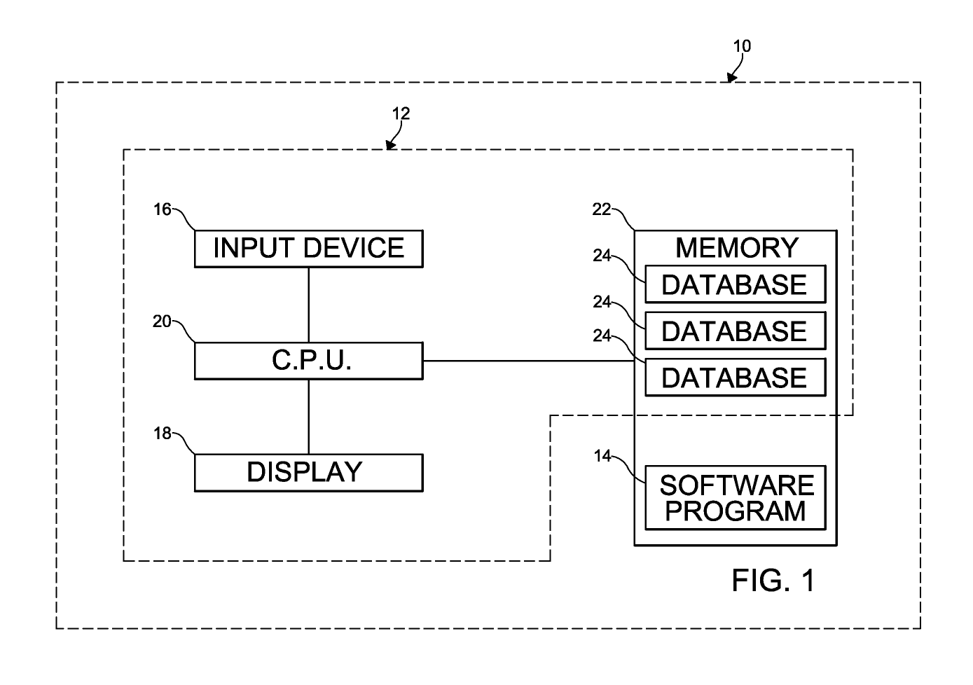

FIG. 1 illustrates a data management system 10 for managing a Professional Employment Organization (PEO). The system 10 includes a device 12 such as a personal computer, for example, and a software program 14. The device 12 includes an input device 16 such as a key board or a touch screen, for example, a display 18, a processor 20, and a memory 22. The data management system 10 is used for managing client companies participating in a Professional Employment Organization in the construction industry and in a union environment, or otherwise.

The processor 20 may be a central processing unit (CPU), for example, or any other type of processor configured to execute various instructions provided by the software program 14 and a user. The processor 20 delivers information and generates reports based on the various instructions.

The memory 22 is in communication with the processor 20 and includes a tangible, computer-readable storage medium. The memory 22 includes a computer-readable data file of stored information such as at least one database 24 that stores data associated with employees, the client companies, unions, and various state and contractual requirements. The stored data may be provided by the software program 14 and/or the user.

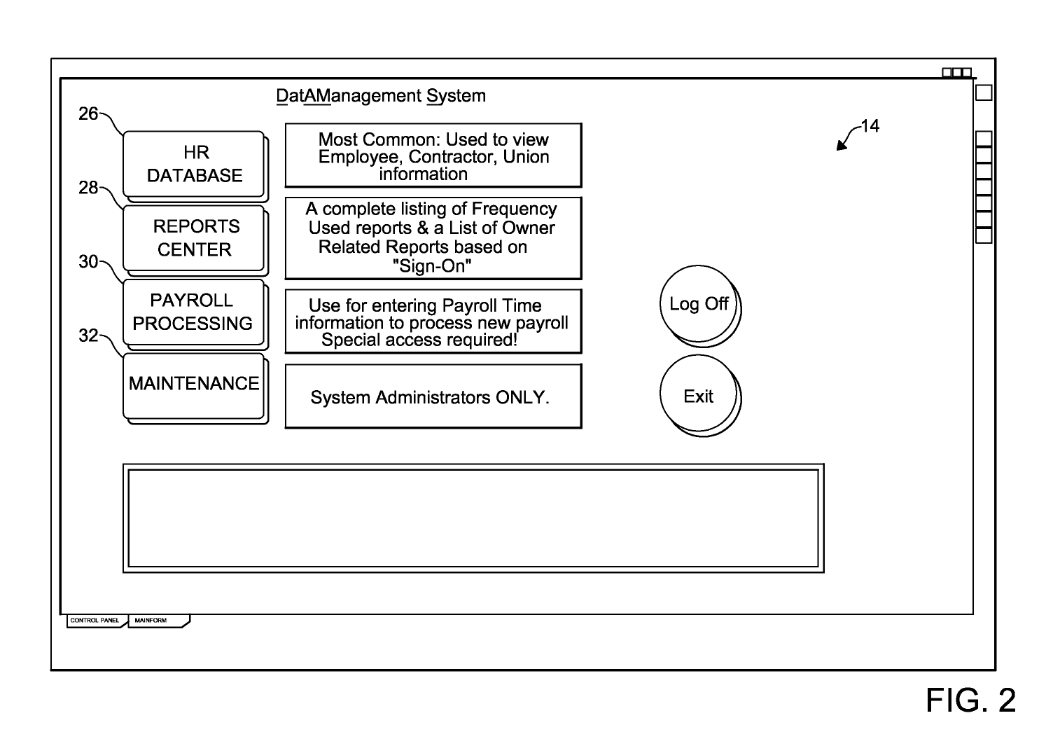

The software program 14 may likewise be stored on the memory 22, and includes a human resources application 26, a reports center application 28, a payroll processing application 30, and system maintenance application 32 (see FIG. 2).

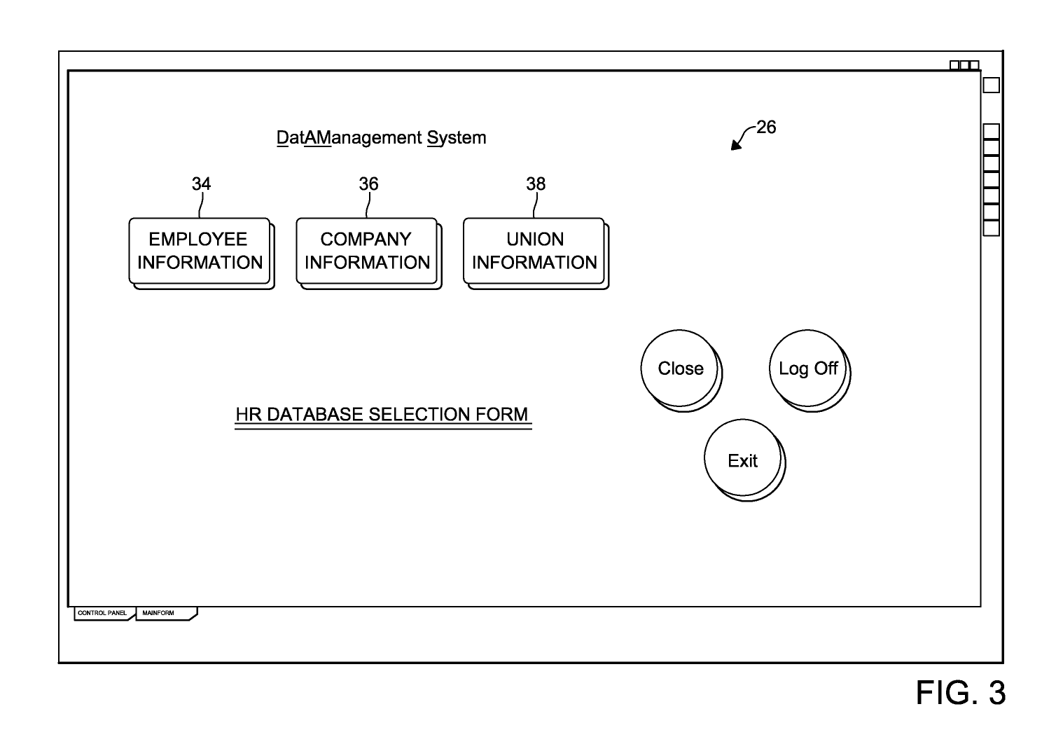

In particular, the human resources application 26, as shown in FIG. 3, includes three modules: an employee module 34, a client company module 36, and a union module 38. The employee module 34, the client company module 36, and the union module 38 each use a combination of multiple databases, variables, tables, forms, and actuating code.

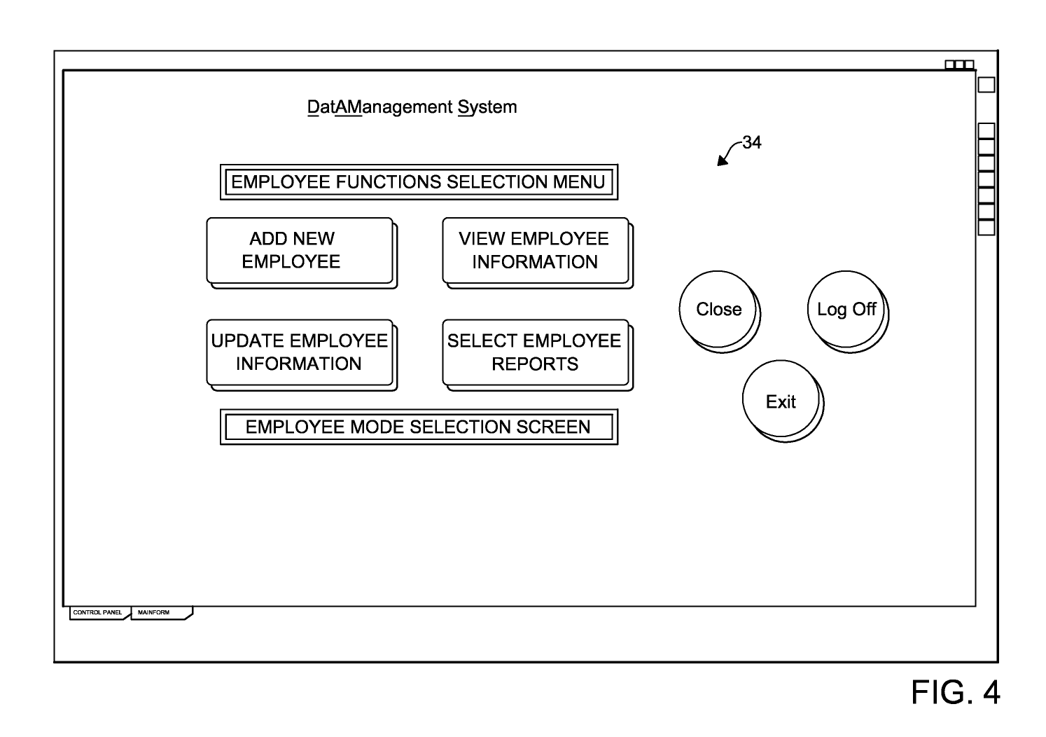

The employee module 34 shown in FIG. 4 includes employee personal and payroll information for each employee included in the data management system 10 such as each employee's full name and home address, for example. The employee module 34 also includes employment and work history information for each employee. A user may add new employees to the data management system using the employee module 34, remove past employees, view, change, and update an existing employee's information, and generate reports relating to an employee's personal and payroll information or an employee's work history. Required information relating to new hires and the new hire process may also be organized under the employee module 34 in whole or in part. Additional functions may be added under the employee module 34 as desired.

The client company module 36 includes information relating to each client company included in the data management system 10 including basic company information, company history, and government, tax, and contractual requirements relating to each client company. Each client company may be one of several client companies existing under a PEO. Client company history may also be included in the client company module 36, and, similar to the employee module 34, a user may add new client companies to the data management system 10 using the client company module 36, remove past client companies, view, change, and update an existing client company's information, and generate reports relating to an client company's basic information, history, and government, tax, and contractual requirements. Additional functions relating to the client company module 36 may be added as desired.

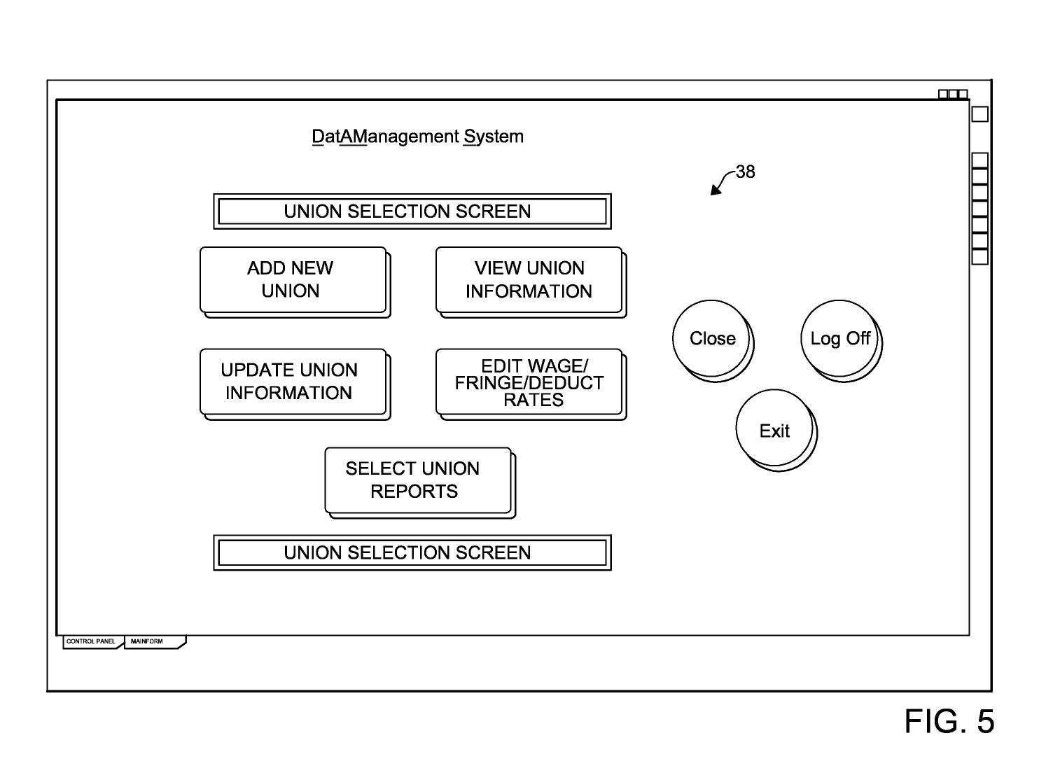

The union module 38 includes data relating to various unions (primarily union locals) in various states and necessary for producing legally and contractually required reports including employment earnings reports, tax reports, and other reports (see FIG. 5). Relevant collective bargaining agreement information and union and audit data may also be entered under the union module 38. Additionally, a user may add new union locals and union information to the data management system using the union module 38, remove union locals, view, change, and update an existing union's information, and generate reports relating to various unions. Additional functions relating to the union module 38 may be added as desired.

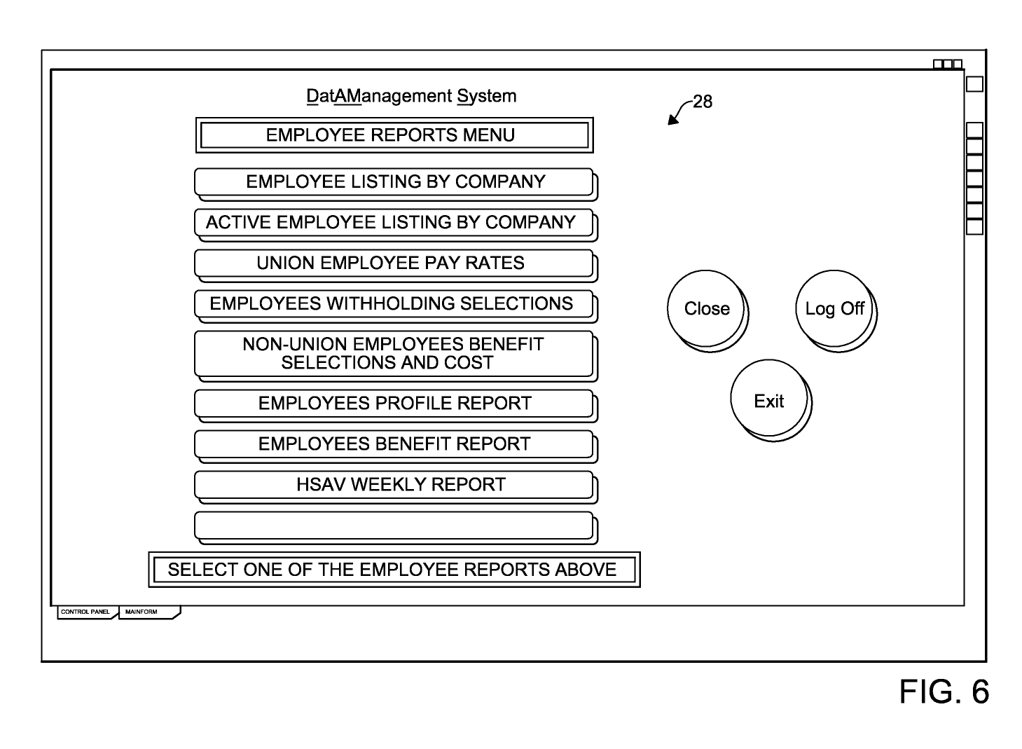

The reports center application 28 generates tax reports, payroll reports, insurance reports, annuities reports, retirement benefits reports, worker's compensation reports, and other reports based on data included in the human resources application 26 (see FIG. 6). Additional reports may be generated using data from any of the data management system 10 applications including the human resources application 26, the reports center application 28, the payroll processing application 30, the system maintenance application 32, and data entered by the user. The reports may report information relating to employee information, client company information, union information, payroll information, related government information and requirements, or other information. Additionally, there are user-accessible payment menus and tables associated with log-on criteria.

The payroll processing application 30 generates invoices and payroll documents including paychecks based on the data included in the human resources application 26, the reports center application 28, the payroll processing application 30, the system maintenance application 32, and the data entered by the user. The payroll processing application 30 may also generate required tax payments, worker's compensation payment, unemployment (UE) payments, union payments, and other necessary payments to be sent to employees, client companies, government agencies, unions, payroll vendors, or other individuals or organizations.

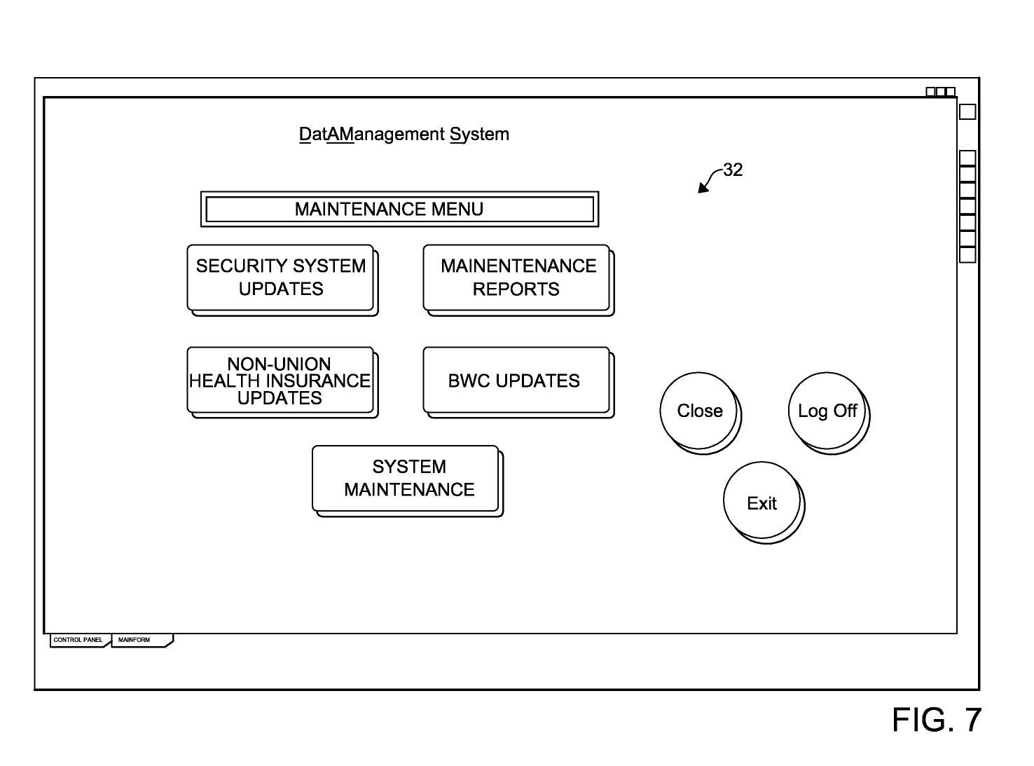

The system maintenance application 32 includes features that maintain and update data within the data management system 10 (see FIG. 7). For example, the system maintenance application 32 may, at any time, update rate tables, information relating to certain groups of employees or client companies, information relating to a particular union or a group of unions, government information, or any other internal data stored in the human resources application 26, the reports center application 28, the payroll processing application 30, and the system maintenance application 32.

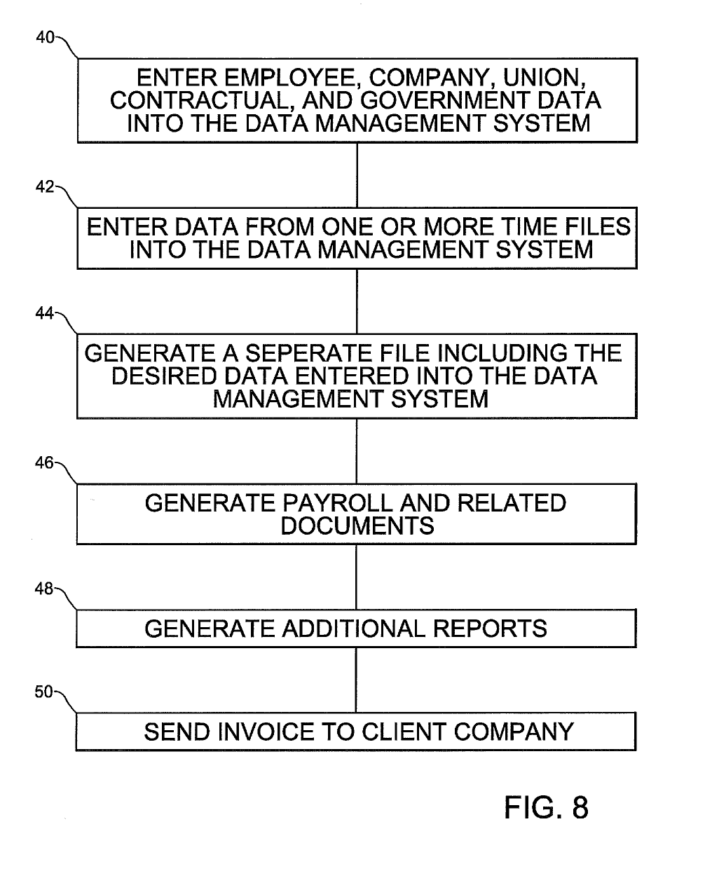

In use, a user enters information 40 into the data management system 10 (see FIG. 8). Information may include, but is not limited to, information and data for one or more employees included in the data management system 10, information and data for one or more client companies included in the data management system 10, information and data for each union included in the data management system 10, and information relating to various government agencies, requirements, and dues. Data in the employee module 34 may include, but is not limited to, employee personal and payroll information, employment and work history, and new hire data. Data in the client company module 36 may include, but is not limited to, basic company information, government, tax, and contractual requirements relating to each client company, and client company history. Data in the union module 38 may include, but is not limited to, legal and contractual requirements for each union, relevant Collective Bargaining Agreement information, and union and audit data.

Additionally, client companies send time files (not shown) for each of their employees and the user processes and enters the information in the time files 42 into the data management system 10. Alternatively, the time files may be transmitted directly to the data management system 10 over a computer network such as the Internet. Where the computer network is employed, the time files are generated on networked computers in communication with the data management system 10.

The information contained in the time files may include employee identification information, number of hours worked, hourly rates, job class, location of work, and various other information. The information from the time files is entered into the human resources database 26 and/or the payroll processing application 30. All necessary information is then pulled from the time files, the human resources application 26, the reports center application 28, the payroll processing application 30, and the system maintenance application 32. A separate file is generated 44 and run through the payroll processing application 30. Payroll calculations are made based on the data included on the separate file generated by the data management system 10. The payroll processing application 30 generates payroll documents 46 such as an invoice or a paycheck for each employee of each client company, for example, payroll is validated, and the paychecks are sent to a payroll vendor, or directly to the employees or the client companies.

A user may also generate additional reports 48 using the reports center application 28, such as payroll reports, tax reports, W-2 forms, job costing reports, and reports relating to retirement benefits, worker's compensation, unemployment, taxes, health insurance, union dues, and annuities for each employee and/or client company. Additional reports may be generated relating to payroll history, client company history, employee history, union reporting, and any other relevant information included in the data management system 10. Any of the reports generated may then be sent to appropriate government agencies, employees, Union Funds Administrators, client companies, or other appropriate individuals or organizations. Additionally, tax payments, union layoff payments, workers compensation payments, and additional payments may be processed and paid through the payroll processing application 30 based on reports generated by the reports center application 28.

A report and/or invoice is sent to each client company 50 outlining payments made to employees, government agencies, and union groups for each employee so that the PEO, payroll vendors, and/or other companies and agencies making payments to or on behalf of each employee may be reimbursed for any payments made.

The data management system 10 is particularly advantageous because the system 10 is designed with an understanding of the unique, complex and transient union worker environment and the associated payroll, government, and union requirements. The data management system 10 allows everything from new hire information, to worker's compensation, to collective bargaining agreements to be accounted for in generating required reports and payments. Furthermore, the system 10 is capable of processing payroll and other information in a complex multi-employer, multi-jurisdictional, environment, and generating required payroll documents and government reports in compliance with applicable state and federal laws, tax requirements, union requirements, and contractual requirements.

Advantageously, the data management system 10 of the present disclosure permits an employee to seamlessly work for various client companies doing various jobs in different states and under different unions, and receive a complete paycheck and job costing report taking into account the legal, contractual, and tax requirements of each state and union involved. Additionally, necessary reports may be generated and sent to each client company, state, and union.

### EXAMPLE

In an illustrative example, a time file is received for a particular client company with at least one employee identified in the time file. The time file has a plurality of fields including social security number*, name*, job code, units* (hours), paycode* (e.g., regular overtime, commission, etc.), the employee's pay rate, the amount, location, union, union work class, and worker's compensation class.

*Indicates a required field.

The time file lists for the employee a first number of hours (e.g., 30 hours) worked in a first location (e.g., Toledo, Ohio—Local 55) under a first union work class (e.g., as a journeyman). The time file also lists for the same employee a second number of hours (e.g., 10 hours) working in a second location (e.g., Marion, Ohio—Local 147) under a second union work class (e.g., as a foreman).

The time file is then entered into the data management system 10. The data management system 10 processes the time file into a payroll input file. In this case, the payroll input file is the result of a calculation by the data management system 10 of the employee's pay, taking into account union rates (e.g., pension, health and welfare, fringe benefits and deductions, etc.) and taxes for the different locations, and specific union work class of the employee at the location.

As part of the processing, the time file data such as paycode and location allows the system 10 to select appropriate employee payrates and union rates from one or more databases in the system 10. For example, the payroll input file will reflect the employee higher pay rate (e.g., $30 per hour) and different union rates as a foreman in Marion, Ohio compared to the pay rate (e.g., $24 per hour) and union rate of the employee as a journeyman in Toledo, Ohio.

The payroll input file is then processed through the payroll processing application 30, which generates paychecks and paycheck details. The data of the payroll input file is calculated based on the pay rates, union rates (deductions), and taxes at the different locations worked by the employee. For example, the employee may be provided a paycheck based on the pay rate and hours worked at each location (($24/hour×30 hours=$720)+($30/hour×10 hours=$300)), for a total pay of $1020 minus applicable taxes for each location and deductions based on union workclass rates at each location, which are also accounted for by the system 10, which maintains records within its databases of tax rates at different locations and the union requirements as described hereinabove.

The payroll process application 30 further provides a payroll archive file that includes details relevant to the payroll generated for the employee (e.g., total pay, taxes, deductions, etc.). The archive file is used by the data management system 10 to further calculate worker's compensation costs, e.g., based on the worker's compensation class listed for the employee in the time file or maintained in the Employee data base.

After the worker's compensation is calculated, the data management system 10 generates the invoices and reports as detailed further hereinabove.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A data management system comprising:
a memory including a computer-readable storage medium having a software program embodied thereon, the software program including a human resources application, a reports center application, a payroll processing application, and a system maintenance application, the memory also containing data from one or more time files; and
a processor for executing instructions provided by the software program for generating one or more payroll documents and one or more reports based on information included in one or more of the human resources application, the reports center application, the payroll processing application, and the system maintenance application, and the data from the one or more time files.

2. The data management system of claim 1, wherein the data management system includes a computer having the processor for executing instructions, the memory including at least one database in communication with the processor, a display, and an input device in communication with the processor, the input device permitting a user to generate the one or more reports and the one or more payroll documents.

3. The data management system of claim 1, wherein the human resources application includes one or more of an employee module, a client company module, and a union module.

4. The data management system of claim 1, wherein the reports center application generates the reports and the reports include at least one of tax reports, payroll reports, insurance reports, annuities reports, retirement benefits reports, worker's compensation reports, and reports pertaining to employee information, client company information, union information, and government information and requirements.

5. The data management system of claim 1, wherein the payroll processing application generates the payroll documents and the payroll documents include at least one of employee paychecks, client company invoices, and government and union payments.

6. The data management system of claim 1, wherein the system maintenance application includes features for maintaining and updating the information included in the human resources application, the reports center, the payroll processing application, and the system maintenance application.

7. The data management system of claim 1, wherein the data management system generates an invoice detailing payments made to and on behalf of one or more employees.

8. The data management system of claim 3, wherein reports may be generated from one or more of the employee module, the client company module, and the union module.

9. The data management system of claim 1, wherein the system is configured to manage a professional employment organization in a union construction environment.

10. A data management system configured to manage a professional employment organization in a union construction environment comprising:
a computer having a processor for executing instructions, a memory including a computer-readable storage medium having at least one database, the memory in communication with the processor, a display in communication with the processor, and an input device in communication with the processor; and
a software program embodied on the memory and including a human resources application having an employee module, a client company module, and a union module, a reports center, a payroll processing application, and a system maintenance application, and data from one or more time files;
wherein the input device permits a user to generate payroll documents and reports based on information included in one or more of the human resources application, the reports center, the payroll processing application, and the system maintenance application, and the data from the one or more time files.

11. The data management system of claim 10, wherein the reports center application generates the reports and the reports include at least one of tax reports, payroll reports, insurance reports, annuities reports, retirement benefits reports, worker's compensation reports, and reports pertaining to employee information, client company information, union information, and government information.

12. The data management system of claim 10, wherein the payroll processing application generates the payroll documents and the payroll documents include at least one of employee paychecks, client company invoices, and government and union payments.

13. The data management system of claim 10, wherein the system maintenance application includes features for maintaining and updating the information included in the human resources application, the reports center, the payroll processing application, and the system maintenance application.

14. The data management system of claim 10, wherein the data management system generates an invoice detailing payments made to and on behalf of one or more employees.

15. The data management system of claim 10, wherein reports may be generated from one or more of the employee module, the client company module, and the union module.

16. A method of managing a professional employment organization in a union construction environment, the method comprising the steps of:
providing a data management system including a memory having a computer readable storage medium with a software program embodied thereon, the software program having a human resources application, a reports center, a payroll processing application, and a system maintenance application;
providing a time file for at least one employee;
generating a separate file including a data set from one or more of the human resources application, the reports center, the payroll processing application, the system maintenance application, and the time file;
generating payroll documents based on the data set;
generating reports based on the data set; and
sending an invoice to one or more client companies detailing payments made to or on behalf of the at least one employee.

17. The method of claim 16, wherein the human resources application includes an employee module, a client company module, and a union module.

18. The method of claim 16, wherein the reports center application generates the reports and the reports include at least one of tax reports, payroll reports, insurance reports, annuities reports, retirement benefits reports, worker's compensation reports, and reports pertaining to employee information, client company information, union information, and government information.

19. The method of claim 16, wherein the payroll processing application generates the payroll documents and the payroll documents include at least one of employee paychecks, client company invoices, and government and union payments.

20. The method of claim 17, wherein the reports may be generated from one or more of the employee module, the client company module, and the union module.
